(19) United States
(12) Patent Application Publication
(10) Pub. No.: US 2016/0171005 A1
(43) Pub. Date: Jun. 16, 2016

(54) Geo-based Information Provision, Search and Access method and software System

(71) Applicant: Alfred Xueliang Xin, Cincinnati, OH (US)

(72) Inventor: Alfred Xueliang Xin, Cincinnati, OH (US)

(21) Appl. No.: 14/752,993

(22) Filed: Jun. 28, 2015

Related U.S. Application Data
(63) Continuation of application No. 14/665,791, filed on Mar. 23, 2015.
Application No. 14/665,791 is a continuation of application No. 14/630,212, filed on Feb. 24, 2015.
Application No. 14/630,212 is a continuation of application No. 14/599,459, filed on Jan. 17, 2015.
Application No. 14/599,459 is a continuation of application No. 14/566,116, filed on Dec. 10, 2014.

(51) Int. Cl. G06F 17/30; G06F 3/0484

(52) U.S. Cl. CPC G06F 17/3087; G06F 17/3053; G06F 3/0484

(57) ABSTRACT

A geo-based information provision, search and access system is capable of allowing location owners to post information or transfer live data via a website connected to the system. The information and data provided are directly linked to locations on a digital map displayed on the website. Users may search a geographic area and select interested category on the website; the digital map displays all or selected locations. By selecting a specific location users may have direct access to the information, and live data such as multimedia programs provided by the location owner. The system may allow third-party data resources to post information and or transfer live data via the system. Users with mobile device installed with mobile application of the system will automatically receive full access of information and live data provided by location owner via wireless network when they are physically within a range of a location.

### BACKGROUND OF INVENTION

1. Field of the Invention

The invented geo-based information provision, search and access system is designed to provide internet and mobile device users with the same updated information, recorded or live data directly provided by location owners based on geo-location.

2. Description of the Invention

The current invention is related to a method and computer software system for information or live data provided by location owners; internet users may search and have direct access on a digital map over internet or GUI (Graphic User Interface) of said information, recorded and live data based on any geographical locations.

Location owners may post their most updated information or recorded or live data via website connected to said system; and any location owners regardless how small or big shall have the same tool to publish their information. Internet users may be able to get most recent updated information or live or recorded video or audio broadcasting from locations owners, local or global wide, by visiting website run by said system with geo-map marked with location data posted by said location owners to said system. All location, business, facilities, entities, financial institutions and government bodies, would stand on the equal ground without being ranked or sequenced by search. General public has the right to equally access information available not based on being selected by search engines based on money paid for commercials.

The same information provided may also be accessed automatically by mobile device users when they travel to and are physically within a range of said location.

### BRIEF SUMMARY OF THE INVENTION

A geo-based information provision, search and access method and software system provide internet website or GUI for location owners to publish their information, data and programs via secured online accounts, and for internet users to search and locate information and programs available and directly accessible over marked locations on a digital map displayed on website of said system.

Location owners get on said website or GUI communicated with said software system and create secured accounts, register their geographical locations or postal addresses, nature and functions of the locations along with other information; select functions and features available within their accounts and publish their information, connect video or audio equipment for live broadcasting or upload recorded audio and video recordings; select sequences of presenting said information, data and or recorded or live programs.

Once they are registered with geographical locations or postal addresses and select to publish their information or data, their geo-position will be marked with image shown nature or functions of the place on a digital map along with name of their business, facilities, entities, government bodies or organization etc.

Any third party website or data resources may be connected via secured connections to said system, and displaying or showing their information or data on said website run by said system.

Internet users get on said website may select a geographical area and a searching category. Places of selected area and or categories will be displayed on a digital map. Once users select a location, information and or data published by said location will be sequentially shown as planned by said location owner.

Users with mobile devices installed with mobile application of said system may automatically receive full access of information and live data provided by a location via wireless network when they are physically within a range of the location.

### BRIEF DESCRIPTION OF DRAWINGS

FIG. 1-A is shown a data searching screen with a text entering box for online users to enter their searching area and or category.

FIG. 1-B is shown a digital map with drop down menu selections with different searching category, and selected location.

FIG. 2-A is shown a selected location displaying last page of information after a sequence of programs and information are shown.

FIG. 2-B is shown another location with live scenes in different sub-locations within a travel resort location.

FIG. 2-C is shown a supermarket published its updated information for the day with video recording clip and highlight sales and product location searching function.

FIG. 2-D is shown a message published by a community board member. To access information targeted to selected audiences or readers, secured access code is implemented in a public domain.

FIG. 3-A is shown first screen mobile application of said system installed on a mobile device.

FIG. 3-B is shown selection screen of said mobile application.

FIG. 3-C is shown options of auto play or alert only.

FIG. 4-A is shown information or data shown from a location when a user with mobile device installed with mobile application of said system walk in a range of a location selected earlier.

FIG. 4-B is shown a simple map marked with interesting places within an ancient Greek town.

FIG. 4-C is shown a supermarket published its updated information for the day with video recording clip and highlight sales and product location searching function on a mobile device.

FIG. 4-D is shown a message published by a community board member. Community members receive messages once they are within a range of said community.

### DESCRIPTION OF THE PREFFERED EMBODIMENTS

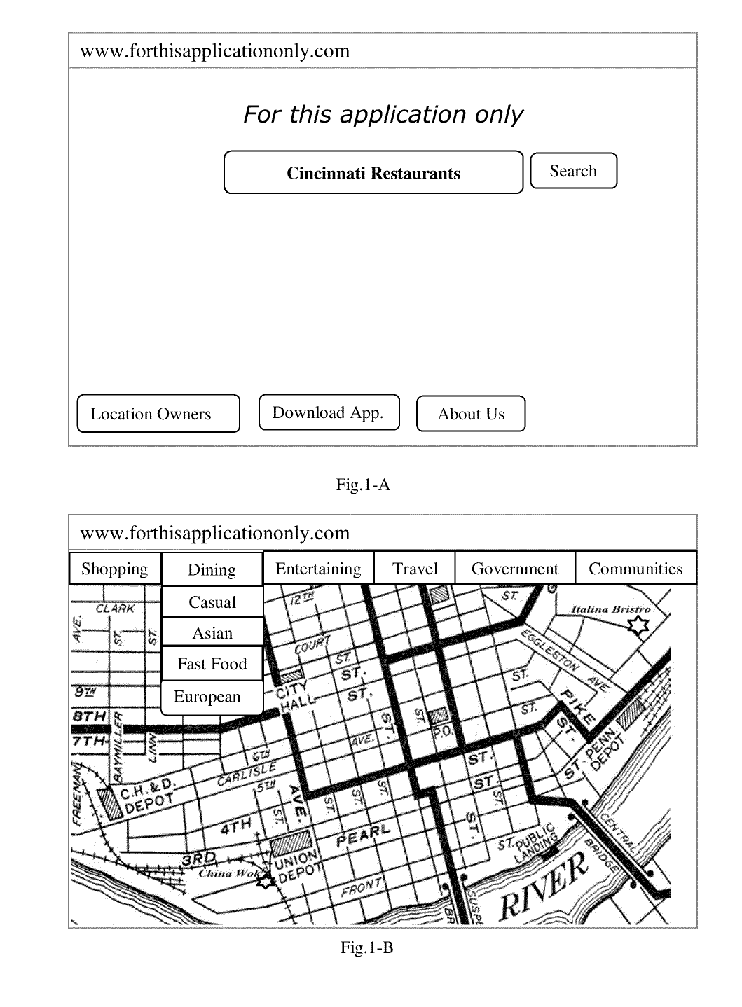

Referencing to drawings in FIG. 1-A, a preferred embodiment of said geo-based information provision, search and access method and software system. An internet user gets on website of said system. Said user selects searching a city and a category of locations. Said website displays a screen of digital map of said city with drop-down menu with a variety of category selections, and selected dining location in that city (FIG. 1-B). Said internet user is interested in a restaurant location.

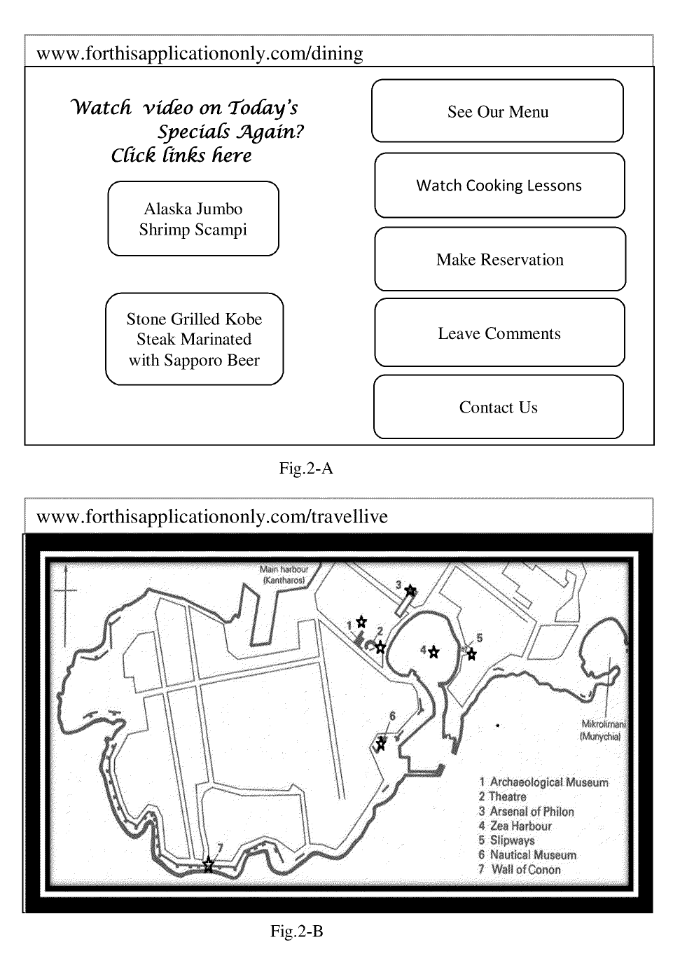

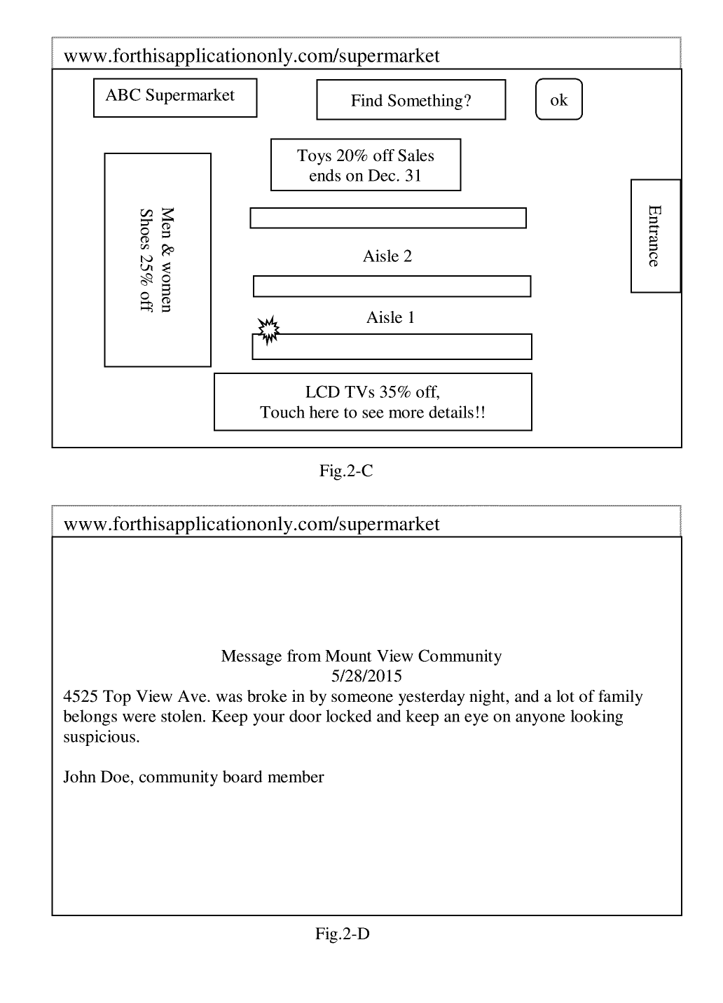

Earlier that day owner of said restaurant just updated new specials for the day through his secured account on said website run by said system. When said internet user selects said restaurant location on said digital map, a variety of information and data are shown in sequence setup by said restaurant owner. First a recorded video clip is played with owner of said restaurant introducing said restaurant with recorded scene of said restaurant and followed by another short video clip with introduction of “Today's Specials” and then a screen shown links leading to more information (FIG. 2-A).

Referencing to drawings in FIG. 2-B, another preferred embodiment of said geo-based information provision, search and access method and software system. An internet user locates an ancient Greek town on said digital map shown on said system, and then selects said location. Another map shown details of said location shown on a window. Said internet user click on sub-location marks on said map, live video scene of sub-location is shown on screen.

Referencing to drawings in FIG. 2-C, another preferred embodiment of said geo-based information provision, search and access method and software system. An online user selects a supermarket location from digital map shown on said system. Said system finds said location belongs to a nationwide supermarket chain, said system then sends signals to computer system of said nationwide supermarket chain, and start from this point, related information and data from database of said nationwide supermarket chain sends to said system and then said system forwards said information and data to online session and displays on said user's computer screen.

A video clip is shown up on a window with greeting from a supermarket staff, and then she briefly introduces what are the hot sales and new products of the day; a floor layout map with highlighted items marked in different section is followed.

A text box with “Find Something?” at the top of the screen. Users may type or give oral commands via a microphone connected to his computer and search for specific location of a product marked on said floor layout map.

Referencing to drawings in FIG. 2-D, another preferred embodiment of said geo-based information provision, search and access method and software system. A resident of a community is out of town. He wants to know anything happening at home, and he gets on said website of said system, and finds location of his community. He clicks on the location and a small secured logon window appeared, he types in password shared by all residents of his community, a newly posted message shown up on said window, and he gets the most updated information back home.

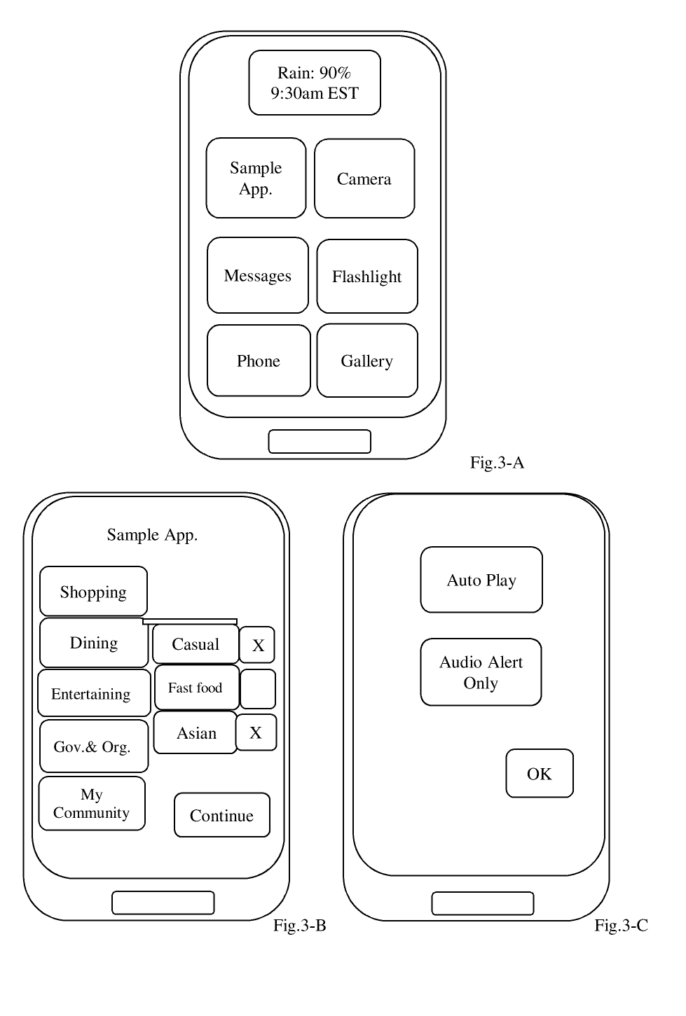

Referencing to drawings in FIG. 3-A, a preferred embodiment of said geo-based information provision, search and access method and software system. A user with mobile device installed with mobile application of said system is going to make a trip for dining and shopping. Said user selects searching categories (FIG. 3-B) and selects “Auto Play” to get information automatically (FIG. 3-C).

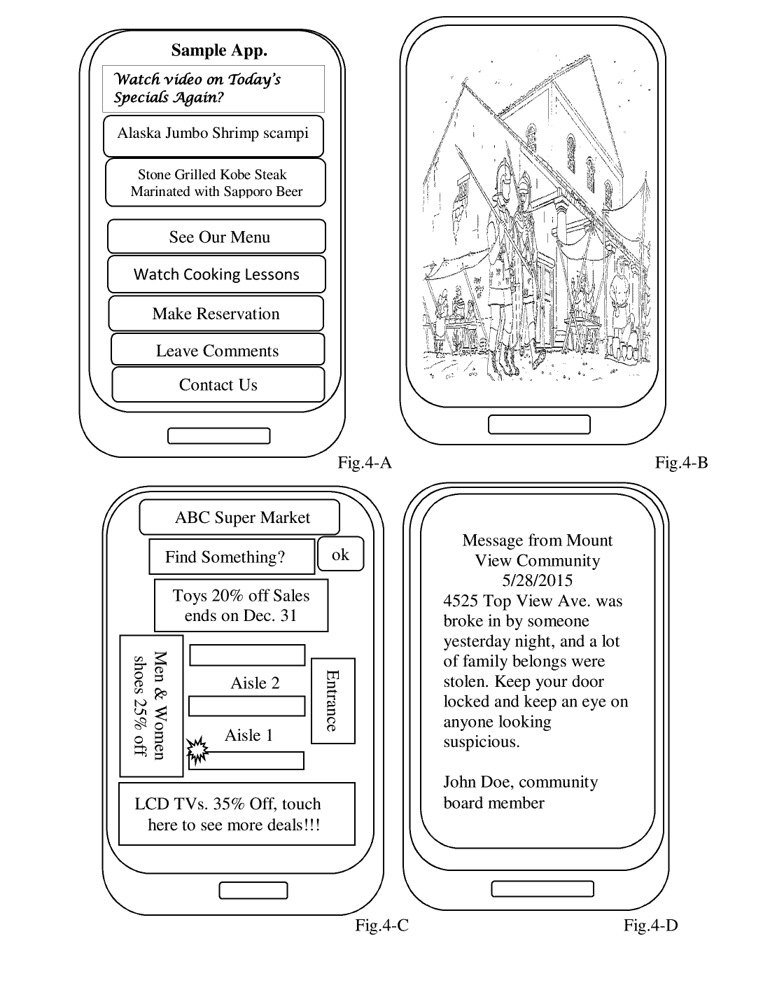

Said system monitors geo-location of said mobile device installed with mobile application of said system and geo-location tracking device. Once said user walks within a closed range of a restaurant that has an account and published information on said system, said system sends commands and launches multimedia screen above locked screen of said mobile device. All information published by owner of said restaurant is shown by sequence as shown on said internet of said system (FIG. 4-A).

Referencing to drawings in FIG. 4-B, another preferred embodiment of said geo-based information provision, search and access method and software system. A traveler with a mobile device installed with mobile application of said system visits an ancient Greek town.

Said system monitors geo-location of said mobile device installed with mobile application of said system and geo-location tracking device. As said traveler enters said Greek town, a recorded video clip pops up on his mobile device, greeted him with brief introduction of the town. Then a very simple map marked with interests points are shown on said mobile device. Said traveler touches those interesting points on said map, live videos are broadcasted to show scenes of the places. Said traveler plans to visits only very interesting places and arranges a short cuts to get to those places even before starts his trip.

When said traveler walks through different places, a recorded video demonstrating live scenes and daily life of said town people is shown on said software application installed on said mobile device accompanied with narrations. As selections setup by owner of said Greek town travel resort on said website, said owner intends to run some more valuable videos for onsite visitors with paid admissions only.

Referencing to drawings in FIG. 4-C, another preferred embodiment of said geo-based information provision, search and access method and software system. A shopper with mobile device installed with mobile application of said system. Said system monitors geolocation of said mobile device installed with mobile application of said system and geolocation tracking device. When said shopper walks in a supermarket. Said system finds said location belongs to a nationwide supermarket chain, said system then sends signals to computer system of said nationwide supermarket chain, and start from this point, related information and data from database of said nationwide supermarket chain sends to said system and then said system forwards said information and data to online session and displays on said user's mobile device.

A video clip shows up on a window with greeting from a supermarket staff, and then she briefly introduces what are the hot sales and new products of the day; a floor layout map with highlighted items marked in different section is followed.

A text box with “Search Product Location” at the top of the screen. Said shopper may type or give oral commands via a microphone connected to his computer and search for specific location of a product marked on said floor layout map.

Referencing to drawings in FIG. 4-D, another preferred embodiment of said geo-based information provision, search and access method and software system. A resident of a community sits at home watching TV. When he hears alert sound from his cellphone installed with mobile application of said system and picks it up. Since he previously logged in said community message board with password provided by message board organizer, a message sent by a community board member is displayed on said cellphone automatically without requiring password for log-in.

The embodiments are mainly illustrations of the invention, advantages of the invention may be learned by practice, realized and attained by means of the elements and combination particularly pointed out in claims. Further it is understood that both the foregoing general descriptions and detailed descriptions are exemplary and explanatory only and are not limited to the invention as claimed.

1. A geo-based information provision, search and access method and system comprising:
a. a software system is capable of allowing location owners to enter and post information and or recorded or live multimedia data via secured accounts over an internet website or UGI (User Graphic Interface) run and administrated by said software system;
b. said information and or recorded or live multimedia data provided by location owners are directly accessible via locations marked on a digital map displayed over said internet website;
c. a software application installed on mobile device is capable of communicating with said software system; and said software system is capable of monitoring location of said software application installed on said mobile device via a geographical location tracking device; and
d. users with mobile device installed with said software application is capable of automatically receiving and accessing said information and or recorded or live multimedia data provided by location owners forwarded by said software system via wireless network when said users travel to and are within a range of said locations and further submit requests to said software system for specific information.

2. The geo-based information provision, search and access method and system of claim 1 wherein said software system is capable of providing location owners with a variety of functions and allowing said location owners to select appropriate functions to post information and or recorded or live multimedia data on said website.

3. The geo-based information provision, search and access method and system of claims 1 and 2 wherein said software system is capable of allowing said location owners to select sequences of information and or recorded or live multimedia data displayed and or played; and is capable of automatically displaying and or playing the entire information and or recorded or live multimedia programs step-by-step by sequences setup by said location owners or by said system.

4. The geo-based information provision, search and access method and system of claims 1 and 2 wherein said software system is capable of allowing location owners to select entire or partial information and or recorded or live multimedia data displayed or played via said website and or via said application installed on said mobile device.

5. The geo-based information provision, search and access method and system of claim 1 wherein said software system is capable of showing accurate date and time on latest information and or data updated by location owner as internet users move curser of a computer on screen of a monitor over a location marked on said digital map on said internet website run and administrated by said software system.

6. The geo-based information provision, search and access method and system of claim 1 wherein said software system is capable of showing concise information when a location is in the process of broadcasting live audio and video programs and or has recorded programs as internet users move curser of a computer on screen of a monitor over a location marked on said digital map on said internet website run and administrated by said software system.

7. The geo-based information provision, search and access method and system of claim 1 wherein said software system is capable of displaying and showing information and or recorded or live multimedia programs automatically step by step setup by owner of a location when said internet users click on a location marked on said digital map on said internet website run and administrated by said software system.

8. The geo-based information provision, search and access method and system of claim 1 wherein said software system is capable of allowing location owners to setup a password and request internet and or mobile device users to enter password to obtain access on information, data, and recorded and or live multimedia programs when internet users click on a location on said digital map, or mobile device users travel to and are within a physical range of said location.

9. The geo-based information provision, search and access method and system of claim 1 wherein said software system is capable of reserving a partial screen area when displaying said digital map on said internet website run and administrated by said system; said partial screen area is capable of displaying information and links of selected websites with no physical locations opening to the general public, and within defined searching category submitted via said website to said system by said internet users.

10. The geo-based information provision, search and access method and system of claims 1 and 2 wherein said software system is capable of providing functions and procedures and allowing sub locations owners within physical parameters of said location to create their own user accounts under said location owner's administrative privileges, and publishing their sub-locations marked on said digital map or floor layout within physical range of said location, and further directly providing information and or data access to internet or mobile device users.

11. The geo-based information provision, search and access method and system of claims 1 and 2 wherein said software system is capable of allowing a location owner to create sub locations on a digital map within parameter of said location and create information and or data allocated and linked to said sub locations; internet and mobile device users may be able to obtain said information and data created for said sub locations either on digital map run by said system or within physical range of each sub location when mobile users travel to said location.

12. A geo-based information provision, search and access method and system comprising steps and functions of:
a software system is capable of allowing location owners to enter and post information and or recorded or live multimedia data via secured accounts over an internet website or UGI (User Graphic Interface) run and administrated by said software system;
said information and or recorded or live multimedia data provided by location owners are directly accessible via locations marked on a digital map displayed over said internet website;
a software application installed on mobile device is capable of communicating with said software system; and said software system is capable of monitoring location of said software application installed on said mobile device via a geographical location tracking device; and
users with mobile device installed with said software application is capable of automatically receiving and accessing said information and or recorded or live multimedia data provided by location owners forwarded by said software system via wireless network when said users travel to and are within a range of said locations and further submit requests to said software system for specific information;
said software system is capable of providing location owners with a variety of functions and allowing said location owners to select appropriate functions to post information and or recorded or live multimedia data on said website;
said software system is capable of allowing said location owners to select sequences of information and or recorded or live multimedia data displayed and or played; and is capable of automatically displaying and or playing the entire information and or recorded or live multimedia programs step-by-step by sequences setup by said location owners or by said system;
said software system is capable of allowing location owners to select entire or partial information and or recorded or live multimedia data displayed or played via said website and or via said application installed on said mobile device;
said software system is capable of showing accurate date and time on latest information and or data updated by location owner as internet users move curser of a computer on screen of a monitor over a location marked on said digital map on said internet website run and administrated by said software system;
said software system is capable of showing concise information when a location is in the process of broadcasting live audio and video programs and or has recorded programs as internet users move curser of a computer on screen of a monitor over a location marked on said digital map on said internet website run and administrated by said software system;
said software system is capable of displaying and showing information and or recorded or live multimedia programs automatically step by step setup by owner of a location when said internet users click on a location marked on said digital map on said internet website run and administrated by said software system;
said software system is capable of allowing location owners to setup a password and request internet and or mobile device users to enter password to obtain access on information, data, and recorded and or live multimedia programs when internet users click on a location on said digital map, or mobile device users travel to and are within a physical range of said location;
said software system is capable of reserving a partial screen area when displaying said digital map on said internet website run and administrated by said system; said partial screen area is capable of displaying information and links of selected websites with no physical locations opening to the general public, and within defined searching category submitted via said website to said system by said internet users;
said software system is capable of providing functions and procedures and allowing sub locations owners within physical parameters of said location to create their own user accounts under said location owner's administrative privileges, and publishing their sub-locations marked on said digital map or floor layout within physical range of said location, and further directly providing information and or data access to internet or mobile device users;
said software system is capable of allowing a location owner to create sub locations on a digital map within parameter of said location and create information and or data allocated and linked to said sub locations; internet and mobile device users may be able to obtain said information and data created for said sub locations either on digital map run by said system or within physical range of each sub location when mobile users travel to said location.
